(19) United States
(12) Patent Application Publication
(10) Pub. No.: US 2013/0257696 A1
(43) Pub. Date: Oct. 3, 2013

(54) FLAT PANEL DISPLAY APPARATUS

(71) Applicant: SAMSUNG DISPLAY CO. LTD., Yongin-si (KR)

(72) Inventors: Kuen-Dong Ha, Yongin-si (KR); Jin-Min Jung, Yongin-si (KR); Tae-Seok Jang, Yongin-si (KR)

(73) Assignee: SAMSUNG DISPLAY CO. LTD., Yongin-si (KR)

(21) Appl. No.: 13/633,084

(22) Filed: Oct. 1, 2012

(30) Foreign Application Priority Data
Mar. 29, 2012 (KR) 10-2012-0032580

(51) Int. Cl. G09G 3/32

(52) U.S. Cl. 345/76

(57) ABSTRACT

A flat panel display apparatus includes a first substrate, a display unit on the first substrate, a terminal unit on the first substrate and adjacent to an outer portion of the display unit; a second substrate on the first substrate and covering the display unit; and a flexible printed circuit board (PCB) on the second substrate and extending beyond an edge of the second substrate. The flexible PCB connects to the terminal unit and includes a curved unit that is bent between the terminal unit and the edge of the second substrate and is formed inside the periphery of the first substrate.

### CROSS-REFERENCE TO RELATED PATENT APPLICATION

This application claims priority to and the benefit of Korean Patent Application No. 10-2012-0032580, filed on Mar. 29, 2012, in the Korean Intellectual Property Office, the disclosure of which is incorporated herein in its entirety by reference.

### BACKGROUND

1. Field

Aspects of the present invention relate to a flat panel display apparatus.

2. Description of the Related Art

Examples of flat panel display apparatuses include liquid crystal display (LCD) apparatuses, field emission display (FED) apparatuses, plasma display panels (PDPs), and organic light-emitting display apparatuses.

Among the flat panel display apparatuses, the organic light-emitting display apparatus includes a pixel electrode, an opposite electrode, and an organic emission layer disposed between the pixel electrode and the opposite electrode. In the organic light-emitting display apparatus, when a voltage is applied between the pixel electrode and the opposite electrode, holes injected from the pixel electrode and electrons injected from the opposite electrode combine with each other to be extinguished in the organic emission layer, thereby generating excitons. Then, the organic emission layer emits light corresponding to energy transferred from the excitons, thereby forming images.

An organic light-emitting device of a flat panel display apparatus can be sealed using a sealing substrate.

### SUMMARY

Embodiments of the present invention are directed to a flat panel display apparatus having a clear appearance by preventing a flexible printed circuit board from exposing out of a panel, and having improved processing reliability and mechanical reliability.

According to an embodiment of the present invention, there is provided a flat panel display apparatus including: a first substrate; a display unit on the first substrate; a terminal unit on the first substrate and adjacent to an outer portion of the display unit; a second substrate on the first substrate and covering the display unit; and a flexible printed circuit board (PCB) on the second substrate and extending beyond an edge of the second substrate, wherein the flexible PCB connects to the terminal unit, and comprises a curved unit that is bent between the terminal unit and the edge of the second substrate and is formed inside the periphery of the first substrate.

The flexible PCB may include a chip-on-film (COF).

The COF may include a driver integrated circuit (DR-IC) for driving the flat panel display apparatus.

The COF may include: a terminal connection unit connected to the terminal unit; the curved unit connected with the terminal connection unit; and an extension unit extending from an end portion of the curved unit toward the second substrate, wherein the DR-IC may be on a side of the extension unit.

The DR-IC may be on an outer portion of the second substrate.

The terminal unit may be spaced from an edge of the first substrate.

The terminal unit may be spaced about 1 mm to about 3 mm from the edge of the first substrate.

A length of a portion of the terminal unit, which is outside of the periphery of the second substrate, may be about 1.6 mm to about 2.5 mm.

The flat panel display apparatus may further include a printed circuit board (PCB) that is electrically connected to the flexible PCB to supply data signals to the terminal unit.

The PCB may be on an outer portion of the second substrate.

The flat panel display apparatus may further include a bracket accommodating the first substrate and the second substrate therein.

The PCB may be on an outer portion of the bracket.

The flexible PCB may extend to the outer portion of the bracket through an opening formed in the bracket.

The flexible PCB may include a terminal connection unit connected to the terminal unit, and the flat panel display apparatus may further include an attaching unit for attaching the first substrate and a portion of the flexible PCB to each other at a location between an end portion of the terminal connection unit and an end portion of the curved unit.

The attaching unit may include silicon.

The second substrate may include a glass material.

The second substrate may include a metal sheet.

The flat panel display apparatus may further include a light blocking unit on an outer portion of the first substrate.

The flat panel display apparatus may further include a polarization film on a surface of the first substrate.

The flat panel display apparatus may further include a light blocking unit on an outer portion of the polarization film.

An image may be displayed on a side of the first substrate by light emitted from the display unit.

The display unit may include an organic light-emitting device.

### BRIEF DESCRIPTION OF THE DRAWINGS

The above and other features and aspects of the present invention will become more apparent by describing in detail exemplary embodiments thereof with reference to the attached drawings in which:

FIG. 1A is a cross-sectional view of a flat panel display apparatus according to an embodiment of the present invention;

FIG. 1B is a schematic diagram illustrating a method of manufacturing the flat panel display apparatus of FIG. 1A, according to an embodiment of the present invention;

FIG. 1C is a front view schematically showing the flat panel display apparatus of FIG. 1A, assembled according to the method illustrated in FIG. 1B;

FIG. 2A is a cross-sectional view of a flat panel display apparatus according to a comparative example;

FIG. 2B is a schematic diagram illustrating a method of manufacturing the flat panel display apparatus of FIG. 2A, according to an embodiment of the present invention;

FIG. 2C is a front view schematically showing the flat panel display apparatus of FIG. 2A, assembled according to the method illustrated in FIG. 2B;

FIG. 3 is a schematic cross-sectional view of a flat panel display apparatus according to another embodiment of the present invention;

FIG. 4 is a schematic cross-sectional view of a flat panel display apparatus according to another embodiment of the present invention;

FIG. 5 is a schematic cross-sectional view of a flat panel display apparatus according to another embodiment of the present invention;

FIG. 6 is a schematic cross-sectional view of an organic light-emitting display apparatus according to another embodiment of the present invention;

FIG. 7A is a cross-sectional view of a flat panel display apparatus according to another embodiment of the present invention; and

FIG. 7B is a schematic front view of the flat panel display apparatus of FIG. 7A.

### DETAILED DESCRIPTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

It will be understood that although the terms “first” and “second” are used herein to describe various elements, these elements should not be limited by these terms. These terms are only used to distinguish one element from another element. Thus, a first element discussed below could be termed a second element, and similarly, a second element may be termed a first element without departing from the teachings of this disclosure.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the present invention will be described in detail with reference to accompanying drawings.

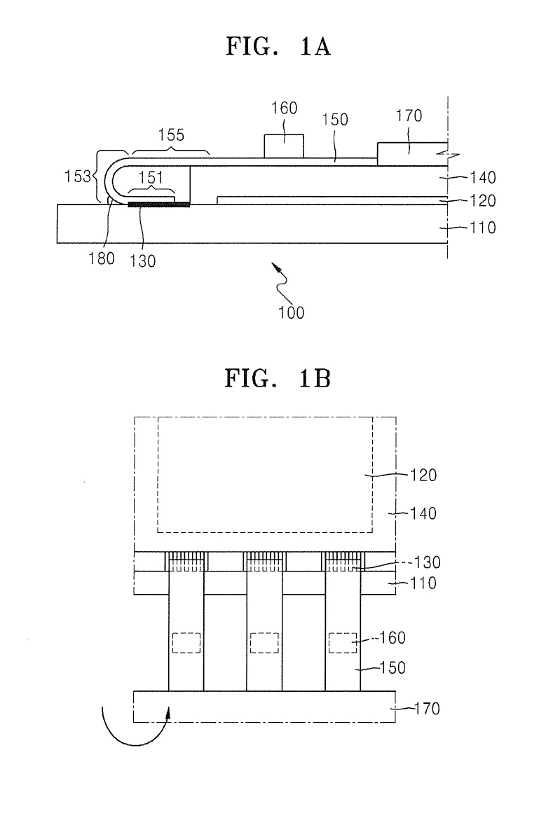

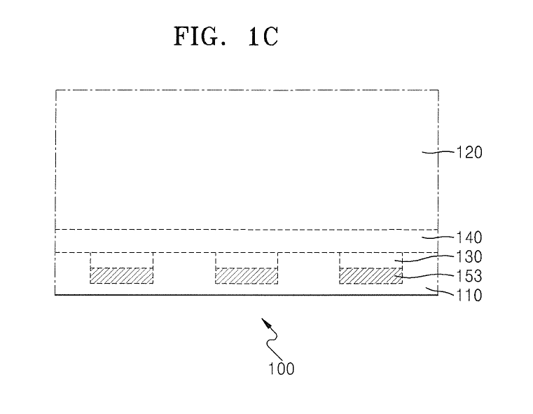

FIG. 1A is a schematic cross-sectional view of a flat panel display apparatus 100 according to an embodiment of the present invention.

Referring to FIG. 1A, the flat panel display apparatus 100 includes a first substrate 110, a second substrate 140, a flexible printed circuit board (PCB) 150, a PCB 170, and a driver integrated circuit (DR-IC) 160.

The first substrate 110 may be a transparent glass substrate mainly formed of SiO₂; however, the present embodiment is not limited thereto.

A display unit 120 is disposed on a surface of the first substrate 110 to display images.

The display unit 120 may include various display devices for displaying images. For example, the display unit 120 may include organic light-emitting display devices, inorganic light-emitting display devices, liquid crystal display devices, or electrophoretic display devices.

A terminal unit 130 is disposed at an outer portion of the display unit 120 on the first substrate 110. The terminal unit 130 electrically connects the display unit 120 and the flexible PCB 150 to each other.

The terminal unit 130 may be spaced about 1 mm to 3 mm from a side of the first substrate 110, and a length of the terminal unit 130 exposed out of the second substrate 140 may be about 1.6 mm to about 2.5 mm.

The second substrate 140 for sealing the display unit 120 is disposed on the surface of the first substrate 110, on which the display unit 120 is disposed.

In FIG. 1, the second substrate 140 may be a substrate or may be a sheet.

The PCB 170 may be disposed at an outer portion of the second substrate 140. The PCB 170 supplies data signals to the first substrate 110.

The PCB 170 and the first substrate 110 may be electrically connected to each other via the flexible PCB 150. The flexible PCB 150 includes a terminal connection unit 151 that is connected to the terminal unit 130, a curved unit 153 that is curved between the terminal unit 130 and the second substrate 140, and an extension unit 155 extending from an end portion of the curved unit 153 to the second substrate 140 side.

In addition, the flexible PCB 150 may be a chip-on-film (COF).

The DR-IC 160 for driving the flat panel display apparatus 100 may be connected to the flexible PCB 150. The DR-IC 160 may be disposed on a side of the extension unit 155 of the flexible PCB 150, and may be disposed on a side facing the outer portion of the second substrate 140.

The flat panel display apparatus 100 may include an attaching unit (not shown) for attaching the first substrate 110 and the flexible PCB 150 to each other between an end portion of the terminal connection unit 151 and an end portion of the curved unit 153. The attaching unit may include silicon 180.

FIG. 1B is a schematic diagram illustrating a method of manufacturing the flat panel display apparatus 100 of FIG. 1A, according to an embodiment of the present invention.

Referring to FIG. 1B, the DR-IC 160 is mounted on the flexible PCB 150, and the PCB 170 is bonded to an end portion of the flexible PCB 150 on which the DR-IC 160 is mounted. After that, the PCB 170 is placed on the second substrate 140 to be attached to the second substrate 140 when the flexible PCB 150 is bent.

FIG. 1C is a schematic front view of the flat panel display apparatus 100 of FIG. 1A, assembled by the processes described with reference to FIG. 1B.

Referring to FIG. 1C, the terminal unit 130 is separated from the outer portion of the first substrate 110, and the flexible PCB 150 is bent toward the second substrate 140 when the terminal connection unit 151 of the flexible PCB 150 is connected to the terminal unit 130. Thus, elements, including the curved unit 153 of the flexible PCB 150 (for example, the terminal connection unit 151 or the extension unit 155), are not exposed out of the first substrate 110 when the flat panel display apparatus 100 is seen from a front portion thereof.

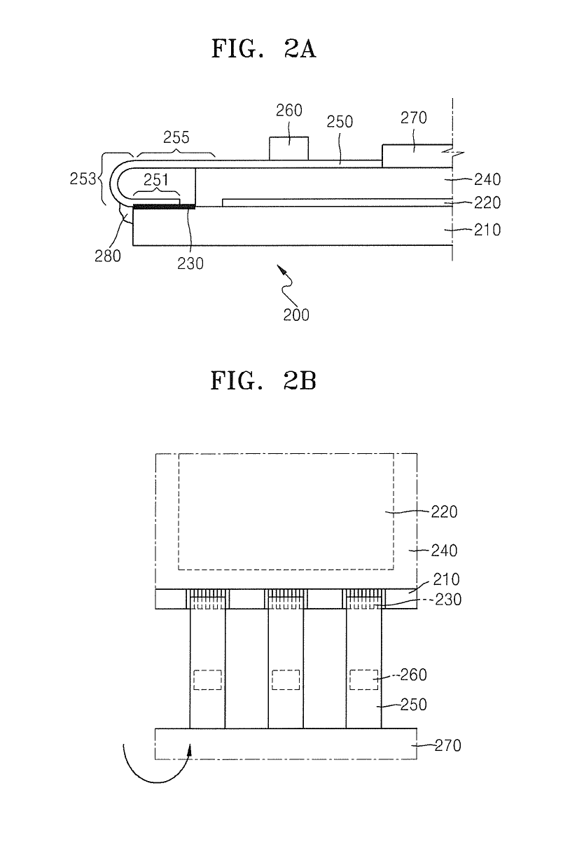

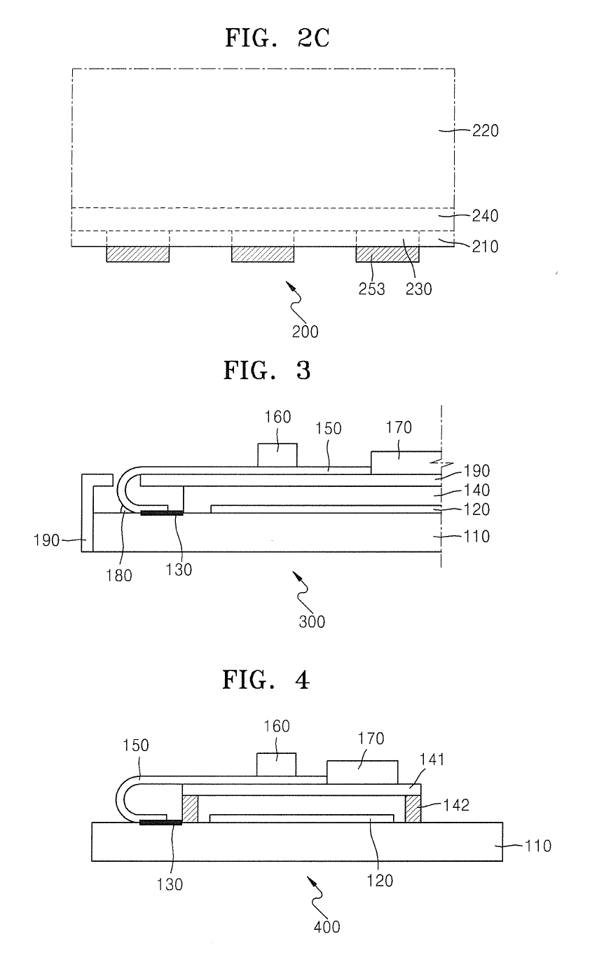

FIG. 2A is a cross-sectional view of a flat panel display apparatus 200 according to a comparative example, FIG. 2B is a schematic diagram illustrating a method of manufacturing the flat panel display apparatus 200 of FIG. 2A, and FIG. 2C is a front view schematically showing the flat panel display apparatus 200 of FIG. 2A, assembled according to the method illustrated in FIG. 2B.

Referring to FIGS. 2A through 2C, in the flat panel display apparatus 200 according to the comparative example, a flexible PCB 250 is exposed out of a first substrate 210, and thus, the flexible PCB 250 is weak against external shock, thereby degrading reliability of the flat panel display apparatus 200. In addition, silicon 280 is applied to a gap between the flexible PCB 250 and the first substrate 210 in order to improve reliability of the flexible PCB 250 and to prevent or reduce moisture infiltration; however, since the applied silicon 280 and the flexible PCB 250 are exposed out of the first substrate 210, the reliability of the flexible PCB 250 is degraded.

Therefore, as shown in FIGS. 1A and 1C according to the embodiment of the present invention, the first substrate 110 is enlarged when compared with that of the conventional art to block or protect the curved unit 153 of the flexible PCB 150, and thus, the flexible PCB 150 is not exposed outside of the first substrate 110. In this case, the flat panel display apparatus 100 may have a clear outer appearance, and the mechanical reliability of the flat panel display apparatus 100 may be improved.

In addition, when the silicon 180 is applied to a gap between the flexible PCB 150 and the first substrate 110, the silicon 180 is not exposed to the outside, and accordingly, the silicon 180 and the flexible PCB 150 may be safely protected.

Referring to FIG. 2B, in the flat panel display apparatus 200 according to the comparative example, since a terminal unit 230 is disposed on an outer portion of the first substrate 210, and a PCB 270 is placed on a second substrate 240, a curved unit 253 (shown in FIG. 2A) of the flexible PCB 250 is inevitably exposed to the outside, as shown in FIG. 2C.

However, as shown in FIG. 1B, when the terminal unit 130 is separated from the outer portion of the first substrate 110, as shown in FIG. 1B, the terminal connection unit 151 of the flexible PCB 150 may be formed inside the periphery of the first substrate 110. In this state, when the PCB 170 is placed on the second substrate 140, the curved unit 153 of the flexible PCB 150 may be disposed inside the periphery of the first substrate 110, as shown in FIG. 1C. Therefore, problems in appearance, processes, and reliability of the flat panel display apparatus 100 caused by the exposure of the flexible PCB 150 may be addressed.

FIG. 3 is a cross-sectional view schematically showing a flat panel display apparatus 300 according to another embodiment of the present invention.

Hereinafter, differences from the flat panel display apparatus 100 described with reference to FIGS. 1A through 1C are described.

Referring to FIG. 3, the flat panel display apparatus 300 further includes a bracket 190. The bracket 190 receives the first substrate 110 and the second substrate 140 therein. In addition, the bracket 190 may be disposed between the PCB 170 and the second substrate 140 for stability. In addition, an opening may be formed in the bracket 190 so that the flexible PCB 150 may extend to the outside of the bracket 190.

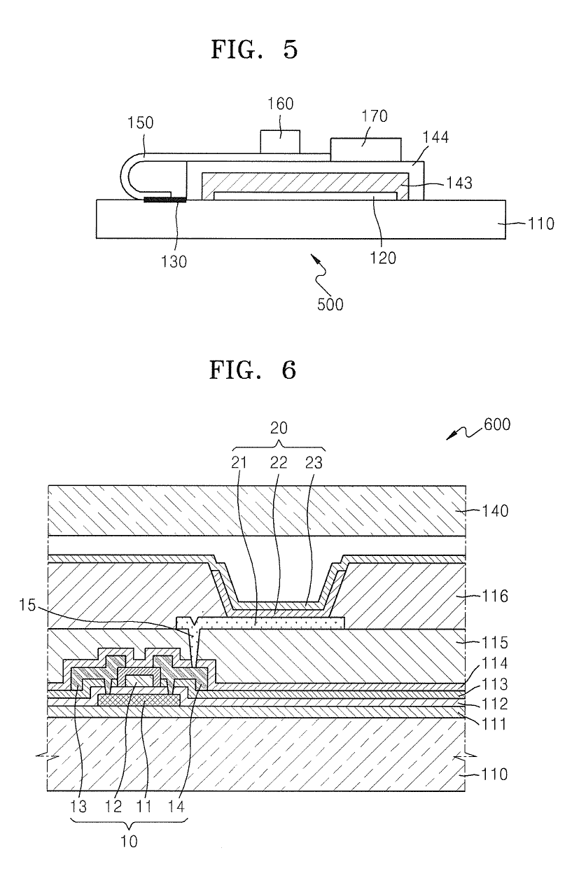

FIG. 4 is a cross-sectional view schematically showing a flat panel display apparatus 400 according to another embodiment of the present invention, and FIG. 5 is a cross-sectional view schematically showing a flat panel display apparatus 500 according to another embodiment of the present invention.

In FIG. 4, a second substrate 141 (refer to 140 of FIG. 1A) of the flat panel display apparatus 400 includes a glass material.

Referring to FIG. 4, the second substrate 141 including the glass material and the first substrate 110 are sealed with each other by a sealing unit 142. The sealing unit 142 may include frit or other suitable materials. In this case, the flexible PCB 150 covers a surface of the second substrate 141 including the glass material.

In FIG. 5, the second substrate (refer to 140 of FIG. 1A) of the flat panel display apparatus 500 is formed of a metal sheet 143.

Referring to FIG. 5, an insulating member 144 is disposed between the metal sheet 143 and the PCB 170. In this case, the flexible PCB 150 covers a surface of the insulating member 144.

FIG. 6 is a cross-sectional view schematically showing a part 600 of an organic light-emitting display apparatus according to another embodiment of the present invention.

Referring to FIG. 6, the organic light-emitting display apparatus, in which the display unit 120 (refer to FIG. 1A) includes an organic light-emitting device 20, includes the first substrate 110, the organic light-emitting device 20, and the second substrate 140.

The organic light-emitting device 20 and a thin film transistor (TFT) 10 that is connected to the organic light-emitting device 20 are disposed on the first substrate 110. In FIG. 6, one organic light-emitting device 20 and one TFT 10 are shown for convenience of description; however, the part 600 of the organic light-emitting display apparatus of the present embodiment may include a plurality of organic light-emitting devices 20 and a plurality of TFTs 10.

The flat panel display apparatuses may be classified into passive matrix (PM) types and active matrix (AM) types according to whether each of the organic light-emitting devices 20 is controlled by a TFT. The organic light-emitting display apparatus of the present embodiment may be applied to both of the PM and AM types. Hereinafter, an AM type organic light-emitting display apparatus is described as an example in the embodiments of the present invention.

A buffer layer 111 formed of SiO₂ and/or SiNx may be further formed on the first substrate 110 in order to improve flatness of the first substrate 110 and to prevent impurities from infiltrating into the first substrate 110.

An active layer 11 of the TFT 10 is formed of a semiconductor material on the buffer layer 111, and a gate insulating layer 112 is formed to cover the active layer 11. A gate electrode 12 is disposed on the gate insulating layer 112, and an interlayer dielectric 113 covers the gate electrode 12. In addition, a source electrode 13 and a drain electrode 14 are disposed on the interlayer dielectric 113, and a passivation layer 114 and a planarization layer 115 are sequentially disposed to cover the source and drain electrodes 13 and 14.

The gate insulating layer 112, the interlayer dielectric 113, the passivation layer 114, and the planarization layer 115 may be formed of an insulating material, and may be formed to have a single-layered structure or a multi-layered structure formed of an organic material, an inorganic material, or an organic/inorganic compound. However, the stacked structure described above is an example, and TFTs having various structures may be used.

A first electrode 21 that functions as an anode electrode of the organic light-emitting device 20 is formed on the planarization layer 115, and a pixel-defining layer 116 is formed of an insulating material to cover the first electrode 21. A set or predetermined opening is formed in the pixel-defining layer 116, and an organic emission layer 22 of the organic light-emitting device 20 is formed in a region defined by the opening. In addition, a second electrode 23 that functions as a cathode electrode of the organic light-emitting device 20 is formed to cover all pixels. Polarities of the first electrode 21 and the second electrode 23 may be changed in other embodiments.

The organic light-emitting display apparatus (e.g., 300 of FIG. 3) is a bottom emission-type apparatus, in which images are displayed toward the first substrate 110. Therefore, the first electrode 21 may be a transparent electrode, and the second electrode 23 may be a reflective electrode.

The first electrode 21 may be formed of ITO, IZO, ZnO, or In₂O₃, and the second electrode 23 may be formed of Li, Ca, LiF/Ca, LiF/AI, Al, Mg, and a compound thereof.

The organic emission layer 22 disposed between the first and second electrodes 21 and 23 may be formed of a low-molecular weight organic material or a high-molecular weight organic material. When a low-molecular weight organic material is used, a single or multi-layer structure including at least one selected from the group consisting of a hole injection layer (HIL), a hole transport layer (HTL), the organic emission layer 22, an electron transport layer (ETL), and an electron injection layer (EIL) may be formed. Examples of available organic materials may include copper phthalocyanine (CuPc), N,N′-di(naphthalene-1-yl)-N,N′-diphenyl-benzidine (NPB), tris-8-hydroxyquinoline aluminum (Alq3), and the like. The low-molecular weight organic material may be deposited in a vacuum deposition method using masks.

When a high-molecular weight organic material is used, an HTL (not shown) may be further disposed on an anode electrode side based on the organic emission layer 22, and PEDOT may be used as the HTL and a high-molecular weight organic material such as a Poly-Phenylenevinylene (PPV)-based material or a polyfluorene-based material may be used.

The second substrate 140 for sealing the organic light-emitting device 20 is disposed on the first substrate 110, including the organic light-emitting device 20, to face the first substrate 110.

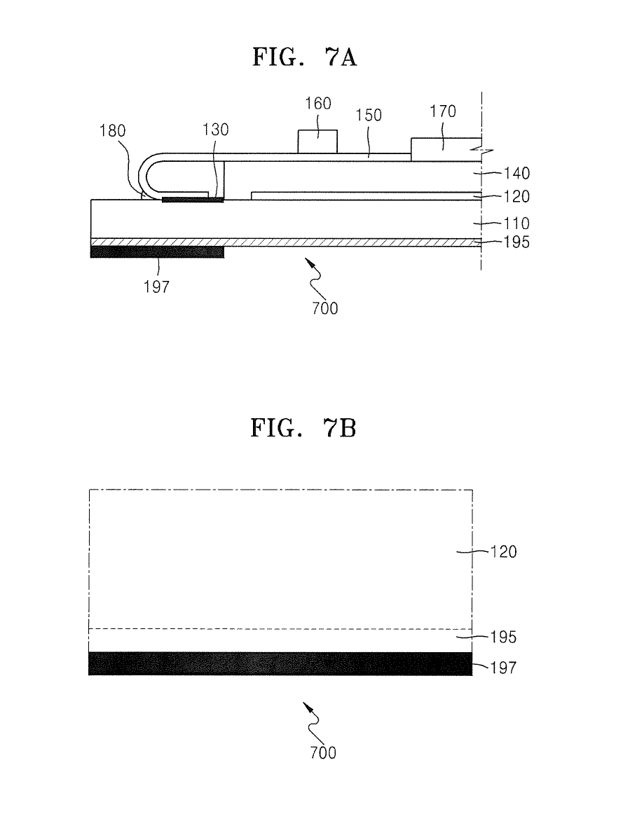

FIG. 7A is a schematic cross-sectional view of a flat panel display apparatus 700 according to another embodiment of the present invention, and FIG. 7B is a schematic front view of the flat panel display apparatus 700 of FIG. 7A.

Hereinafter, differences of the flat panel display apparatus 700 from the flat panel display apparatus 100 described with reference to FIGS. 1A through 1C are described.

Referring to FIGS. 7A and 7B, in a bottom emission-type flat panel display apparatus in which the images are displayed toward the first substrate 110, a polarization film 195 may be disposed on a surface of the first substrate 110. In particular, in a flat panel display apparatus including organic light-emitting devices, the polarization film 195 is disposed on a substrate through which an image is displayed in order to address a problem of bright room contrast ratio.

Since a transmittance of the polarization film 195 is around 50%, the bonding region of the flexible PCB 150 may be projected or visible through the polarization film 195 and may be visible to a user.

However, according to the present embodiment, a light blocking unit 197 is disposed on an outer portion of the polarization film 195 so that wires disposed on the outer portion of the polarization film 195 or the bonding region of the flexible PCB 150 are not visible. In addition, the light blocking unit 197 may be directly formed on an outer portion of the first substrate 110.

Thus, as shown in FIG. 7B, the light blocking unit 197 is formed on an edge portion of the polarization film 195, and an outer appearance of the flat panel display apparatus 700 may be desirable and neat.

According to a flat panel display apparatus of the present invention, the following effects may be obtained:

Since a flexible PCB is not exposed outside of a panel, a clean front glass or no-bezel type design may be realized when the flat panel display apparatus is seen from a front side.

In addition, since the flexible PCB is formed inside of the panel, the flexible PCB may be prevented from being damaged during manufacturing processes.

Also, since the flexible PCB is formed inside of the panel, mechanical reliability of the flat panel display apparatus may be improved.

While the present invention has been particularly shown and described with reference to exemplary embodiments thereof, it will be understood by those of ordinary skill in the art that various changes in form and details may be made therein without departing from the spirit and scope of the present invention as defined by the following claims, and their equivalents.

What is claimed is:

1. A flat panel display apparatus comprising:
a first substrate;
a display unit on the first substrate;
a terminal unit on the first substrate and adjacent to an outer portion of the display unit;
a second substrate on the first substrate and covering the display unit; and
a flexible printed circuit board (PCB) on the second substrate and extending beyond an edge of the second substrate,
wherein the flexible PCB connects to the terminal unit and comprises a curved unit that is bent between the terminal unit and the edge of the second substrate and is formed inside a periphery of the first substrate.

2. The flat panel display apparatus of claim 1, wherein the flexible PCB comprises a chip-on-film (COF).

3. The flat panel display apparatus of claim 2, wherein the COF comprises a driver integrated circuit (DR-IC) for driving the flat panel display apparatus.

4. The flat panel display apparatus of claim 3, wherein the COF comprises:
a terminal connection unit connected to the terminal unit;
the curved unit connected with the terminal connection unit; and
an extension unit extending from an end portion of the curved unit toward the second substrate,
wherein the DR-IC is on a side of the extension unit.

5. The flat panel display apparatus of claim 4, wherein the DR-IC is on an outer portion of the second substrate.

6. The flat panel display apparatus of claim 1, wherein the terminal unit is spaced from an edge of the first substrate.

7. The flat panel display apparatus of claim 6, wherein the terminal unit is spaced about 1 mm to about 3 mm from the edge of the first substrate.

8. The flat panel display apparatus of claim 7, wherein a length of a portion of the terminal unit, which is outside of a periphery of the second substrate, is about 1.6 mm to about 2.5 mm.

9. The flat panel display apparatus of claim 1, further comprising a printed circuit board (PCB) that is electrically connected to the flexible PCB to supply data signals to the terminal unit.

10. The flat panel display apparatus of claim 9, wherein the PCB is on an outer portion of the second substrate.

11. The flat panel display apparatus of claim 9, further comprising a bracket accommodating the first substrate and the second substrate therein.

12. The flat panel display apparatus of claim 11, wherein the PCB is on an outer portion of the bracket.

13. The flat panel display apparatus of claim 12, wherein the flexible PCB extends to the outer portion of the bracket through an opening formed in the bracket.

14. The flat panel display apparatus of claim 1, wherein the flexible PCB comprises a terminal connection unit connected to the terminal unit, and
the flat panel display apparatus further comprises an attaching unit for attaching the first substrate and a portion of the flexible PCB to each other at a location between an end portion of the terminal connection unit and an end portion of the curved unit.

15. The flat panel display apparatus of claim 14, wherein the attaching unit comprises silicon.

16. The flat panel display apparatus of claim 1, wherein the second substrate comprises a glass material.

17. The flat panel display apparatus of claim 1, wherein the second substrate comprises a metal sheet.

18. The flat panel display apparatus of claim 1, further comprising a light blocking unit on an outer portion of the first substrate.

19. The flat panel display apparatus of claim 1, further comprising a polarization film on a surface of the first substrate.

20. The flat panel display apparatus of claim 19, further comprising a light blocking unit on an outer portion of the polarization film.

21. The flat panel display apparatus of claim 1, wherein an image is displayed on a side of the first substrate by light emitted from the display unit.

22. The flat panel display apparatus of claim 1, wherein the display unit comprises an organic light-emitting device.
